(19) United States
(12) Patent Application Publication
(10) Pub. No.: US 2005/0057038 A1
(43) Pub. Date: Mar. 17, 2005

(54) Coated lay flat business form assembly with integral cards

(76) Inventor: Jesse D. Crum, St. Fort Scott, KS (US)

Correspondence Address: WARD KRAFT, INC., P.O. BOX 938, FORT SCOTT, KS, 66701, US

(21) Appl. No.: 10/689,944

(22) Filed: Oct. 21, 2003

Related U.S. Application Data
(63) Continuation-in-part of application No. 10/663,131, filed on Sep. 16, 2003.

(51) Int. Cl. B42D 15/00

(52) U.S. Cl. 283/106

(57) ABSTRACT

The present invention relates to a discontinuous business form construction created from differential substrates that has been provided with one or more removable elements such as cards, labels, tags and differential substrates. The form construction is desirably a composite form having at least first and second discrete portions one of which carries one or more removable elements and the other of which provides an information carrying portion. The form construction of the present invention is produced in such a manner so that when a series of the forms are placed into a stack, such as in a tray that supplies forms to a printing station or a laser printer, there is no significant pad lean or distorted stack arrangement. That is, the stack of forms retains a relatively square, rectangular or cube shape as opposed to one having a sloped configuration, a high end and a low end, due to differential thicknesses between the two portions of the construction. In addition, the form construction of the present invention enables the feeding of a form along the long side or in the landscape position and reduces the surface affinity between the forms. The present invention further includes a coating for anchoring or holding ink, toner, adhesive and/or cohesive and combinations thereof to the construction.

### CROSS-REFERENCES TO RELATED APPLICATIONS

The present invention is a continuation in part of U.S. Ser. No. 10/663,131, filed Sep. 16, 2003 the disclosure of which including that found in the claims is incorporated herein by reference.

### FIELD OF THE INVENTION

The present invention relates to a discontinuous business form construction created from differential substrates that have been provided with one or more removable elements such as cards, labels, tags and differential substrates. The form construction is desirably a composite form having at least first and second discrete portions one of which carries one or more removable elements and the other of which, in an exemplary arrangement, provides an information carrying portion. The form construction of the present invention is produced in such a manner so that when a series of the forms are placed into a stack, such as in a tray that supplies forms to a printing or processing station (e.g. a laser printer) there is no significant pad lean or distorted stack arrangement. That is, the stack of forms retains a relatively square; rectangular or cube shape as opposed to one having a sloped configuration (a high end and a low end) due to differential thicknesses between the two portions of the construction. In addition, the form construction of the present invention enables the feeding of a form along the long side or in the landscape position and has reduced surface affinity between successive forms. The present invention further includes adhesive or cohesive sealing patterns that enable the business form construction to be folded and sealed so as to create a secure mailing construction or in the alternative, a secure and confidential document for distribution of membership cards, identification cards, other removable elements and the like. In addition, the present invention also includes a novel coating composition that serves to anchor toner, ink, adhesive, cohesive and combinations thereof to the synthetic portions of the assembly.

### BACKGROUND OF THE INVENTION

Information carrying structures such as business forms with removable cards, tags and labels have long been used to convey information to the holder, presenter or recipient of the business form. When utilizing removable cards, such cards include but are not limited to insurance, medical, identification (ID cards), membership applications, admissions, tickets, collections, special events, credit or debit cards, temporary passes and the like.

One traditional means used to deliver cards was to place the card in a carrier that had cut out notches to receive two or more corners of the card and then deliver the card through the mail, by use of a courier or by such other means in order to place the card in the possession of the intended recipient. However, while effective in delivering the card to the end user, the process of assembling the mailing could be cumbersome in that it required the carrier to be printed and then to subsequently cut notches in the carrier to create areas to hold the corners of the card and then, finally placing of the card in the carrier. Next, the carrier was typically folded and then usually placed in an envelope prior to mailing the card to the recipient. In addition to being a somewhat cumbersome manufacturing process, the process itself can be expensive, in that it requires a number of pieces, a supply of cards, carriers and envelopes. Thus, there has been a continuing trend to move away from such processes and reduce the number of separate components and steps required to prepare such a business form construction.

Another means by which to deliver cards that arose out of the need to reduce such processing complexities as discussed above was to simply affix the card to the top surface or uppermost portion of the sheet of paper or the like. This product configuration eliminated the need to die cut notches in the carrier to create an area to receive the card as well as the step of having to align and place the corners of the card within the cut out area of the carrier.

In this construction, where the card rides on top of the surface of the substrate, the card was normally affixed to the sheet of paper through the use of a spot adhesive that would hold the card in place during handling and transport, yet allow the card to be readily removed by the recipient. Alignment was not a critical concern and hence processing speeds improved. However, this construction, while eliminating some of the drawbacks associated with the above mentioned arrangement of putting a card into a carrier assembly, still suffered from unforeseen difficulties and created new problems in that the card was placed on the surface of the sheet of paper which then created a raised area that often resulted in jamming of the printer or feeding apparatus when attempting to image or process the paper substrate with the card attached. Unfortunately, while this particular construction resulted in manufacturing efficiencies it created difficulties for the end users as such product configurations had to be carefully or even gingerly fed through the printer, again slowing distribution to the end user and resulting in significant frustration of the end user or printer of the form construction.

In a still further effort to overcome the above-mentioned problem of differential thicknesses created by the inclusion of the card on the surface of the paper or substrate, manufacturers then sought to create holes, pockets or die cut areas in a substrate that corresponded in size and shape to the card that was to be placed into the receiving area. In such a construction, when the card was placed into a receiving area, the card would not rest above the level of the surface of the paper substrate, but instead may extend below the bottom surface of the sheet of paper. Once again the manufacturer, while solving the problem of having the card extend above the surface of the sheet, faced the problem of alignment and having to carefully position the card within the receiving area.

In addition to alignment, the manufacturer also had to hold and secure the card in the receiving area. As such and in order to hold the card in place in the carrier, another web of material was affixed over the hole in the form of a patch, a continuous strip that ran edge to edge or segments of material that would hold the card in position, see for instance U.S. Pat. No. 5,403,236. While effective in over coming the problem with the card being placed on top of the substrate, such a construction then suffered from additional problems.

The addition of the supplemental material over the area of the cut out to receive the card again created a raised portion that extended either below the surface of the paper or alternatively both above and below the surface of the paper, depending upon the thickness of card structure. Again, the construction could still only be fed in a small amount to the printer as the area of double thickness around the card area created a hump, or a sloped configuration when several card carrying sheets were placed in a stack. This limited the amount of cards that could then be placed in the tray to be fed to the printer or processing equipment.

A still further solution to the above-mentioned dilemma was to create a calendared area or recess in the paper substrate, by crushing an area of the paper that corresponded to the size of the card. The card was then placed within the substrate. This eliminated the need to apply a patch to hold the card in the area of a cut out into which a card would be inserted; however, this construction still suffers from other drawbacks. The thickness of the card material is still more than the thickness of the paper substrate. As such, the top surface of the card would still be above the top surface of the paper substrate leading to an arrangement that still suffered from difficulties in processing the card due to the differential thickness arising out of the card sticking out of the well or recessed area. In addition, the manufacturer still had to accurately align the construction so that it would fit within the area of the recess or well.

A still further business form and card construction was then contemplated to eliminate the need to align and place a card, usually plastic, in a well, recess, die cut area, etc. This solution was to simply affix a web of card material, again usually plastic, to the substrate. This enabled the manufacture to die cut the material directly in line with the imaging of the information carrying portion of the construction. However, such constructions while attractive from a manufacturing perspective also did not completely solve the processing of the form construction.

The web of card material still needed to be connected to the portion or web of information carrying material. In one arrangement, one web is affixed or partially juxtaposed directly onto an edge or side of the other portion by adhesive, crimping, mechanical fastening or the like. As expected however, this arrangement creates a bump in the form and contributes again to processing difficulties in attempting to feed the construction through the printer. Again, such arrangements had to be carefully processed through the printer and only a few forms at a time could be stacked into a feed tray for a printer or processing equipment.

An attempt to resolve the problem of the discontinuous surface area was to place the webs next to or adjacent one another and then place a small strip of material, such as tape to connect the two webs together. While this solved some additional problems for card manufacturers and end users, still other problems persisted. The area covered by the strip of tape creates a zone having a higher thickness than the rest of the configuration. This again creates problems of feeding the construction through the printer. In addition, the use of two different types of materials, the card material may also be thicker than the information portion of the substrate and as such when the products are placed into a stack they then again create a sloped arrangement, thus limiting the number of cards that can be placed in a feed tray for a printer.

A still further difficulty encountered by such two part constructions is that the web of card material, typically a plastic or synthetic film, may build up excess static when placed in a stack thus making feeding of the forms difficult as they tend to stick to one another in the tray or other feeding mechanism.

In addition to problems related to static build-up or the like, the synthetic material also would not adequately hold or anchor toner, ink, adhesive or cohesive to the business form assembly resulting in the smearing, smudging or complete removal of the indicia or adhesive provided by the manufacturer or end user of the assembly. Moreover, such readily removable materials enable forgery or other unauthorized manipulation of the card material.

A yet still further card arrangement was to provide a single sheet of paper and then apply a plastic coating over the area from which the cards were to be created such as through the use of die cutting or the like. While this eliminated problems related to joining discontinuous materials, it reverted to the problem associated with having a heightened thickness of material in the area of the cards again giving rise to a discontinuous stacking arrangement and other difficulties enumerated above, such as static build up and toner, ink, adhesive, etc. holdout.

In addition to the foregoing enumerated drawbacks of these prior art constructions, modifications were also attempted with respect to the processing or printing equipment, more specifically to the feed trays in order to compensate for the pad lean or slope of the stack of products. Such modifications to the feed trays included the insertion of shims under one portion of the form structure, the form having the lesser thickness (that end without the card) in order to facilitate feeding of the forms. This modification led to more exotic configurations of feed trays including spring loaded and adjustable shims in order to accommodate differing types of form products. However, while the modifications to the equipment appeared to address the problem of pad lean, it nonetheless required the end user or printer to make sure that the appropriate tray, shim, or adjustment had been made to the equipment prior to beginning run of the product. In those situations where the operator forgot to make the equipment change then, the finishing process was subjected to further delays and jamming as indicated above. Moreover, many end users or printers were simply unwilling to make the additional investment in such modified trays.

An additional processing problem also resulted from the use of such prior art constructions. Such constructions, due to the difficulty in feeding the forms, required the forms to be fed in a portrait arrangement into the printer, that is in connection with a form size of 8½″ by 11″, the 8½″ side was fed to the printer first. By feeding the short side of the form into the printer first, the printer, which calculates wear of the print head based on the total running length of the print job, was subjected to additional wear in running a regular pass of product as opposed to being able to run a regular pass of forms when fed in a landscape, or long side first, arrangement through the printer. As can be expected, this also resulted in a further delay in processing the forms by the end user or printer as well as additional wear and tear of the print head.

One such example of a prior art product having an integrated card construction with cohesive sealing means is presented in U.S. Pat. No. 6,179,201 in which an integrated card construction is described with a particular cohesive pattern disposed around the margins of the form so as to enable sealing of the form with the card structure contained therein. However, such a construction does not overcome the difficulties described above.

What is needed therefore, is a business form card combination that overcomes the foregoing difficulties, such as pad lean or sloped stacks, static buildup, smearing and loss of adhesive and imaging and other problems so that larger numbers or amounts of cards can be placed in a feed tray as well as the problem of bump or humps in the form construction is mitigated and the cost of manufacture is reduced so that the construction can be produced economically as well as expeditiously.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention pertains to a business form carrying one or more removable elements in a relatively homogenous assembly. The construction of the present invention through the use of several leveling aids enables the business form element combination to lay substantially flat in a tray or stack prior to being fed to a printer or other processing equipment for further handling. As such, the business form of the present invention can be fed to a printer in a landscape or long side or edge first format (e.g. with a 8½×11 inches, the 11″ side), thereby speeding processing time of the order and potentially reducing print head wear. In addition, the present invention also includes a coating applied to synthetic portions of the assembly that serves to anchor or hold ink, toner, adhesive, cohesive and or combinations thereof to the assembly.

In one embodiment of the present invention a business form is described and includes a first substrate having a first property and having first and second longitudinal side edges and first and second transverse end edges. The business form assembly also includes a second substrate having a second property and the second substrate is joined to the first substrate along one of the side or end edges. The business form assembly also includes at least one removable element from one of the first and second substrates. A coating is also applied to at least a portion of one of the first and second substrates so as to anchor the toner, ink, adhesive, cohesive and combinations thereof to the first and second substrates. In addition, the business form assembly also includes a plurality of patterns disposed between one of the sides or end edges of at least one of the first and second substrates, the plurality of patterns is applied to at least one of the first and second substrates and the plurality of patterns spaced from one another. At least one of the plurality of patterns connects the first substrate to the second substrate. The business form card assembly with its plurality of patterns and the first and second substrates create a substantially planar business form assembly having at least one removable element.

In a still further embodiment a method of communicating the benefits of a business form having a removable element assembly, is described and includes the steps of initially producing a number of business form assemblies having a removable element, with the assemblies having at least first and second portions. The first and second portions have different thicknesses. One of the first and second portions having at least one removable element that creates at least a portion of the different thickness and each of the first and second portions having a pattern of material disposed thereon to create a substantially planar business form assembly so that when placed in a stack with other business form assemblies having a removable element, the stack will have a square, cube or rectangular configuration. Next, marketing collateral is created with respect to using the business form assemblies. The business form assemblies are then sold in connection with the marketing collateral to customers or end users and then the business form assemblies are distributed.

In a yet still further embodiment, a business form card assembly, is described and includes a substrate having first and second portions, with the first and second portions being joined one to another through a first pattern of material applied along an edge of each of the first and second portions. One of the first and second portions has a second pattern of material disposed thereon and spaced from the first pattern. At least one removable element is contained within one of the first and second portions, with the removable element having a different thickness than at least one of the first and second portions. The first and second patterns cooperating with the removable element and first and second portions to form a substantially coplanar form assembly. The first and second portions with the removable element and the first and second patterns of material are connected to additional business form card assemblies to create a continuous business form arrangement having a removable element. The continuous business form arrangement can then be wound on itself to form a roll of business form assemblies with at least one removable element.

In a still further embodiment a stack of business form assemblies with at least one removable element creating a different thickness in the business form assembly, is described and includes a plurality of business form assemblies, each of the assemblies having a first and second portions joined to one another by a first pattern of material and one of the first and second portions having at least a second pattern of material to create a substantially planar assembly. The plurality of business assemblies form with the removable element and the first and second patterns of material forms a square, cube or rectangular shaped stack ranging from about 2 to about 10,000 or more assemblies.

In a still further embodiment of the present invention, a coating for use in the present invention suitable in anchoring toner, ink, adhesive, cohesive and combinations thereof of to a substrate is described and includes a first component including a pigment less material ranging from about 0.01% to about 90% by weight and at least a second component ranging from about 0.01% to about 90% by weight of an absorbing agent.

The present embodiments are intended to be exemplary illustrations of the present invention and it should be understood that the invention is capable of other configurations within the scope of the specifications provided herein.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts one face of the present invention showing the position of an exemplary card format and use of a plurality of patterns and coatings and adhesive suitable for use in creating the lay flat construction of the present invention;

FIG. 2 illustrates a further embodiment of the present invention and provides the opposite face of the lay flat business form card assembly of the present invention;

FIG. 3 provides a side elevation view of the patterns and adhesive and coatings used to provide for the lay flat assembly of the present invention;

FIG. 4 shows one face of the present invention and provides an alternate sealing arrangement used in creating the lay flat assembly of the present invention;

FIG. 5 illustrates the opposite face of the business form card construction of the present invention as shown in FIG. 4;

FIG. 6 represents a side view of the present invention illustrating the positions of sealing adhesives and coating area;

FIG. 7 shows the present invention in a stacked configuration as would appear in a tray for a printer and illustrating the relatively square, rectangle or cube shape of the present invention; and

FIG. 8 provides a block diagram relating to the use of the present invention in a landscape format.

### DETAILED DESCRIPTION OF THE INVENTION

The present invention is now illustrated in greater detail by way of the following detailed description, but it should be understood that the present invention is not to be construed as being limited thereto.

Surprisingly, it has been found that through the use of leveling aids, such as a plurality of patterns, business form combinations with removable elements having a thickness different than that of the rest of the business form can be produced to overcome the foregoing difficulties and can be manufactured in an economical and efficient manner.

It has also been found unexpectedly that the use of a formulation, including a generally pigment less material, in combination with an absorbing agent, when coated onto the synthetic portion of the present assembly anchors the cohesive, adhesive, toner and ink to the portion of the assembly, so that the indicia or adhesive or cohesive is not wiped off, smeared or smudged during subsequent processing or handling.

The term “patterns” as used herein refers to continuous strips, sheets, lines, shapes, spots or elements, discontinuous segments, spots, shapes or elements as well as regular and irregular placement of such items. Patterns may also refer to combinations of the above mentioned items such that one pattern may be a continuous strip, another segmented elements and a still further an irregular placement of dots or the like. Any combination of patterns is possible depending on the need or application of the manufacturer or the end user. In additions, the pattern can be prepared in order to accommodate a particular theme, season, event, trade dress, and the like.

The term “formula” as used herein refers to a composition utilized to hold or anchor toner, ink, adhesive, cohesive and combinations thereof to the business form assembly.

The patterns applied to one portion of a form may have a different property, thickness or composition than another pattern of material applied to a different portion of the form assembly. For example, about a 1 mil thick material may be applied to a portion of a substrate having a thickness of about 5 mils whereas a second portion of the form having a thickness of about 3 mils may require the addition of about 3 mil thick material to create the necessary leveling of the form in order to create a coplanar configuration. The foregoing is provided for exemplary purposes and the invention should not be so limited.

The patterns may be formed from strips, segments, dots, geometric elements of material such as glassine, machine glazed paper, highly calendared paper, plastic materials such as polyethylene based materials (PET) and the like as well as from coatings, (wax, starched, silicone, ammonia, alcohol based) inks, other formulas and other materials which generally do not adhere sheets together when the sheets are placed in a stack. It is also desirable that the material, coating or inks are selected so that they reduce surface affinity between the sheets, thereby enabling the sheets to release from the stack readily and facilitate the feeding and handling of the sheets by the printer or processing device.

Where machine glazed, highly calendared sheets, glassine or the like materials are used, the material is adhered to each of the substrates typically through the use of adhesives, including but not limited to cold glues, hot melts, acrylics and other suitable adhesive or cohesives that have sufficient bonding strength to secure the material to the form assembly. Alternately, “dry technology” coatings can be used to hold the plies or layers together through the use of curing energy (e.g. UV) after the coating is applied and the sheets or elements juxtaposed on one another and then upon peeling, the frangible bond is destroyed. Such a coating can be created by using UV30LI available from Northwest Coatings of Oak Creek, Wis. and then subject to UV energy such as from a UV lamp or bulb.

The adhering or bonding coating is used to secure the material to the substrate may be applied by flood coating, pattern or spot coating, transfer coating or other means known in the industry. The coating may be the full length and width of the material or may be applied so that the edges of the material extend slightly beyond the pattern of adhesive laid down.

The term “leveling aid” is used to refer to a plurality of patterns that enable the business form, removable element combination to lay generally or substantially flat, either in a single sheet arrangement or in a stacked configuration such as is used or placed in a tray in order to feed the business form, removable element combinations into a printer or other processing equipment. The leveling aid or aids offset the differential thicknesses that exist between the removable element, first and second portions of the form or any or all of these. The leveling aid or aids may be provided or applied in varying thicknesses, lengths, widths or coat weights to offset the differential thicknesses of the form assembly or portions thereof.

The term “plurality” as used herein refers to more than one pattern applied to the substrate to facilitate the leveling of the form assembly. That is, the patterns are used to create an assembly that is substantially planar when several business form assemblies are placed in a stack such as is used in connection with a feed tray or the like.

A “stack” as used herein refers to a stack of individual assemblies or sheet and may range from about 2 up to 10,000 or more sheets or assemblies in a stack.

The term “removable elements” refers to items such as cards, labels, chips, coins, tickets, tags and the like as well as portions of substrates that have a differential thickness compared with the remainder of the business form to which it is attached, connected or otherwise configured in arrangement therewith and may be removed form the form assembly.

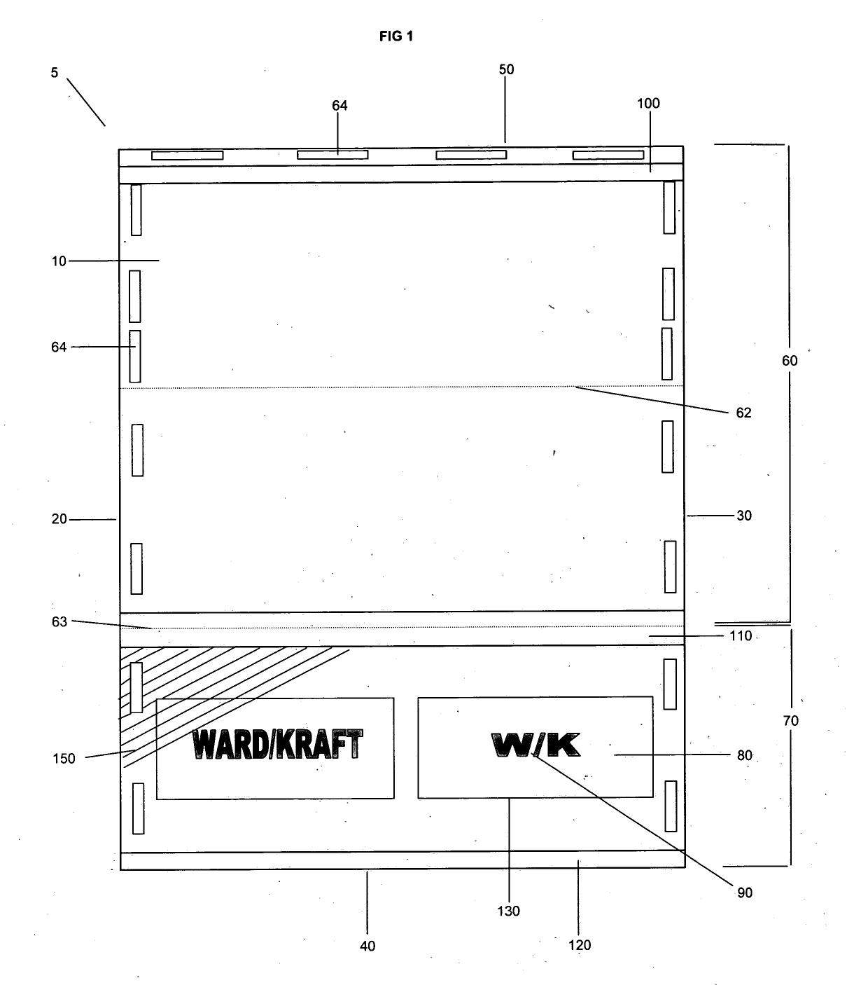

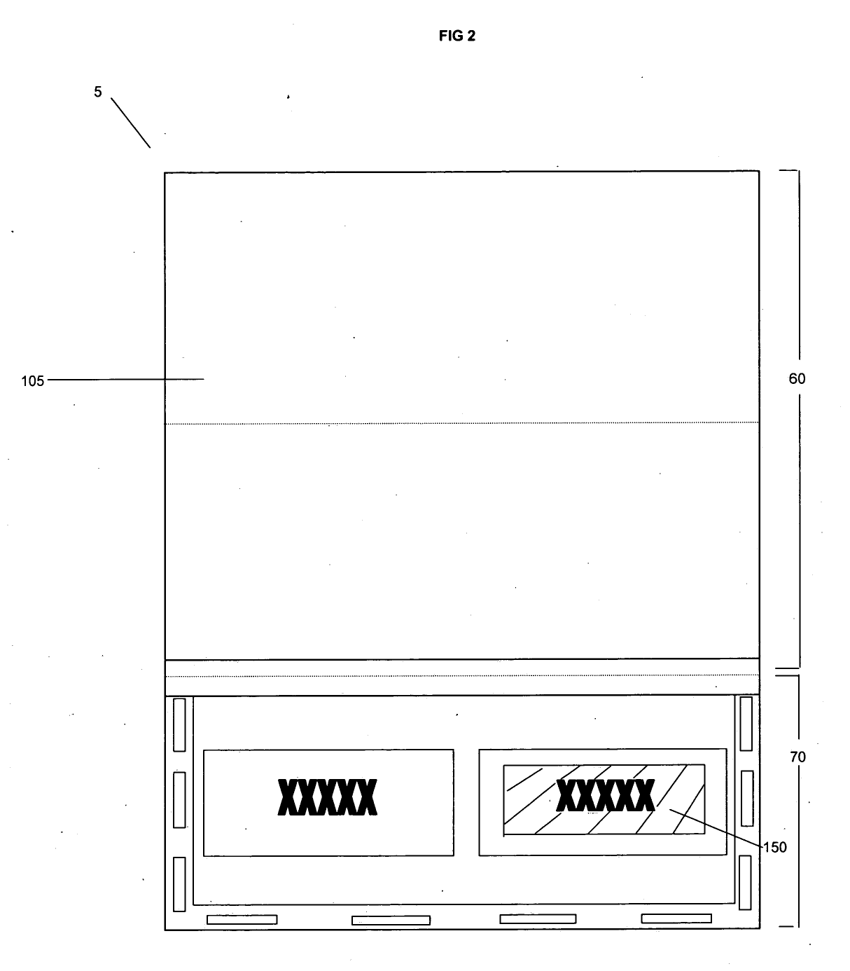

Turning now to FIG. 1 of the present invention, the business form card assembly is generally depicted by reference to numeral 5. As shown in FIG. 1, one side of the business form card assembly 10 is provided. The business form card construction has first and second longitudinally extending side edges 20 and 30, and first and second transversely extending end edges 40 and 50. The business form card assembly 10 has a first face and a second face (shown in FIG. 2) which is opposite to the first face. A first portion 60 is typically used to carry information related to the card assembly, however, such portions may also be left blank or carry additional items such as labels or other cards. First portion 60 is generally capable of receiving printed information on each of the faces of the paper or substrate surface and generally carrying information related to the card offering or the mail, such as account numbers, dial in information, user data and the like.

The first portion 60 may be selected from any suitable stock such as cellulosic based material including paper, card and tag stock, pressure sensitive material and the like. However, films, both plastic and metalized films are also suitable for use for the first portion. In an exemplary embodiment the material selected for the first portion ranges usually from 20 pound bond paper to 100 pound stock, typically tag or card stock. Generally, stock for the first portion is greater than 32 pound stock, but the invention is not so limited thereby. Where the first portion is a pressure sensitive material, film or metalized layer, a corresponding weight sheet is utilized in connection with the present assembly. The first portion 60 may also be provided with one or more fold lines 62, 63 that enable the assembly 5 to form a mailer or other secure document upon sealing.

It should-be understood that reference to the longitudinally extending side edges and transversely extending end edges includes both portions 60 and 70 with the understanding that each of the portions would have their own set of transversely extending end edges and longitudinally extending side edges. As such, reference to each end edge and sides is not regularly repeated in connection with the rest of the description provided herein.

In order to affect the sealing of the business form assembly of the present invention, an adhesive or cohesive pattern 64 is applied along one or more of the longitudinally extending side edges and or transversely extending end edges and typically around the perimeter of the form. The perimeter or margin may also be provided with perforations or tear strips (not shown) so that upon receipt the strips may be removed.

If the business form assembly of the present invention is to be used in creating a “C” fold mailer or construction and shown in FIGS. 1 and 2 both of the longitudinal side edges 20 and 30 on one face of the business form assembly 5 are provided with patterns of adhesive or cohesive 64. Each of the transversely extending end edges may also be provided with adhesive or cohesive 64 in order to fully seal the business form assembly, however the additional sealing means may not be necessary for all constructions. In addition, to complete the “C” folding structure, a pattern of adhesive or cohesive is also applied to a portion of the back or second face of the business form assembly (FIG. 2), so that when a portion of the front or first face is brought into contact with the portion of the back or second face, and sealing pressure is applied, a bond is created. Such a pattern is only necessary when a pressure sealing cohesive is used. Pressure sensitive adhesives, such as a permanent, removable or repositional pressure sensitive adhesive would bond on contact with the substrate.

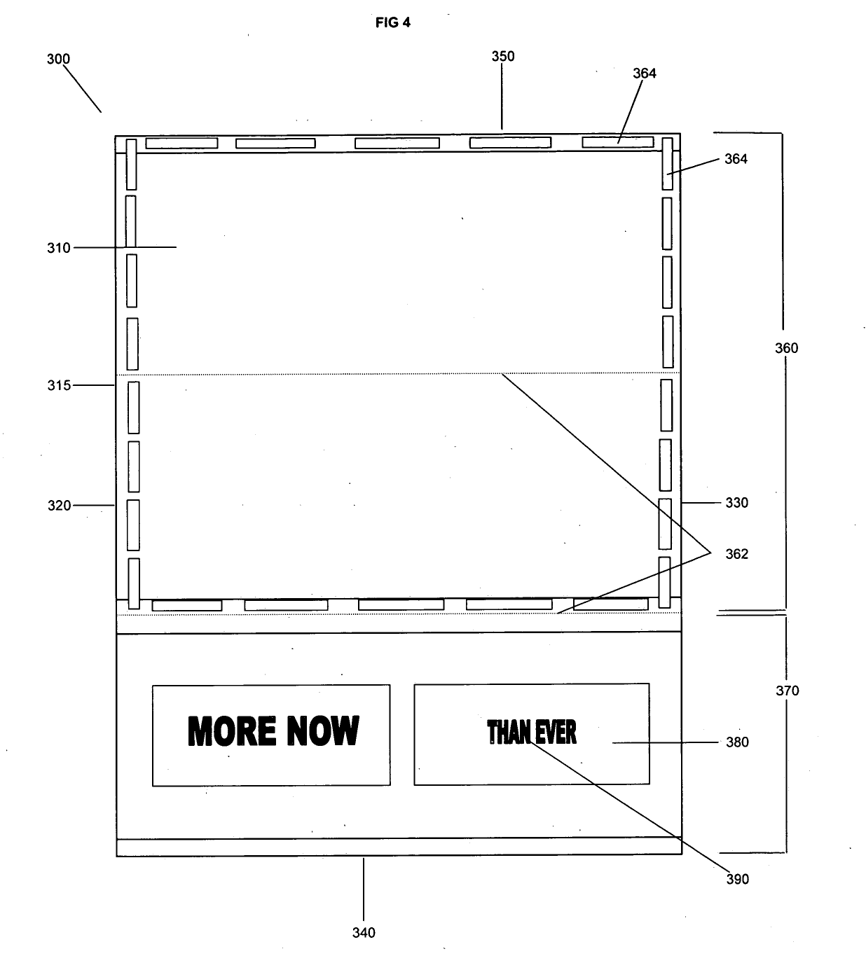

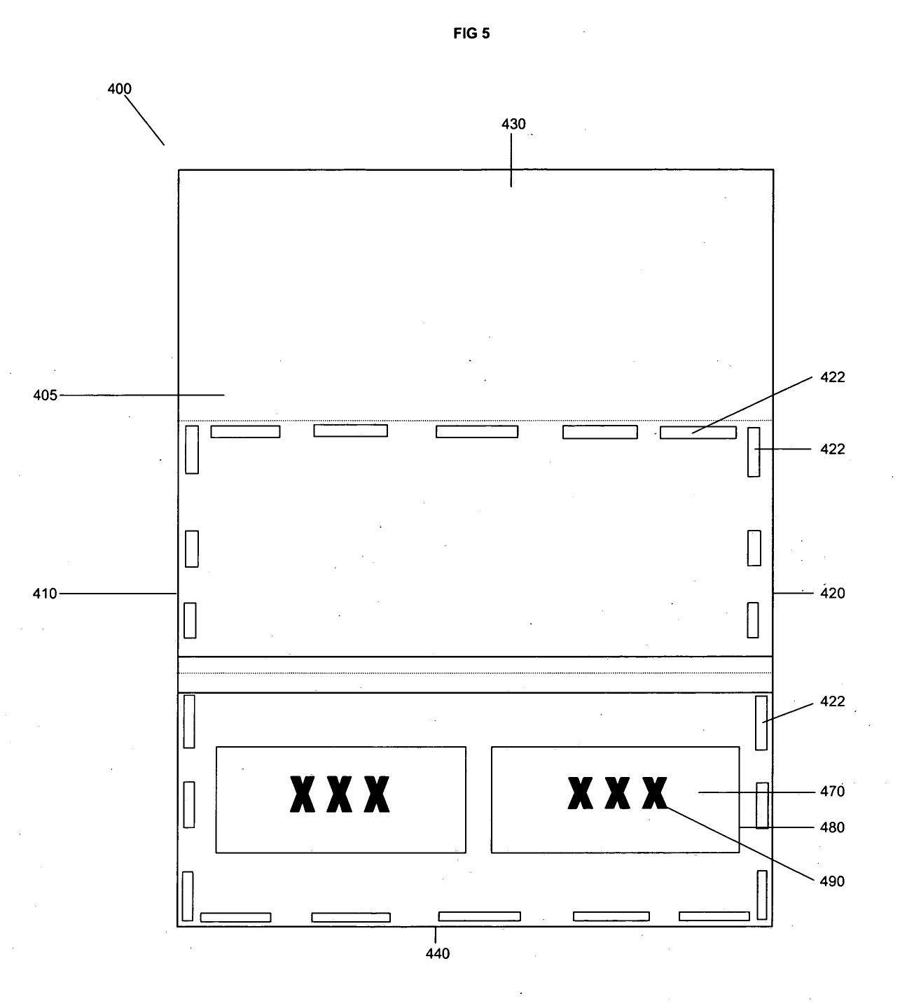

If a “Z” fold construction is the one that is contemplated (FIGS. 4 and 5), then approximately two thirds of the front face 360 perimeter is provided with an adhesive or cohesive 364 and two thirds of the back face perimeter is provided with an adhesive or cohesive 422, opposite the end of the front face. As such, when the substrate is folded in an accordion fashion (“Z” folded), the patterns will match up and create a sealing arrangement as is readily understood by those having skill in the art. The foregoing arrangement is only necessary, where a pressure sealing cohesive is used and required to seal the form through the use of mating or matching patterns of cohesive.

Other patterns of adhesive may of course be used in the creation of the mailer or present construction, such as a spot pattern placed at each of the corners, segmented strips of adhesive and the like. The patterns may appear as continuous, discontinuous, regular or irregular arrangement of elements. Each element of the pattern may be applied individually, with spacing between successive elements or appear immediately adjacent one another.

The adhesive or cohesive that may be suitable for use with the present invention includes permanent, removable or repositionable adhesives as well as pressure sealing cohesive such as described in U.S. Pat. No. 4,918,128. Other suitable adhesive formulations may also be suitable for use in the present construction.

The use of the term “pattern” as provided herein includes spots, segments, strips, dots, other geometric shapes and configurations that may be used to accomplish the sealing of the business form card assembly 5.

The business form card assembly 5 of the present invention also has a second portion 70 which is formed of a material that is sufficient to die cut one or more removable elements 90 such as cards as provided in the illustrative embodiment. The card arrangement can also include a self laminating construction in which after a recipient adds some additional indicia such as a signature, the recipient folds over the adjoining portion which adheres to the first card via adhesive exposed by the liner removal or other activation creating a protected card enclosure. Other removable elements include tags, tickets, coins, chips, passes and the like.

It should be understood that the type, shape, number and arrangement of the removable elements is discretionary and any such configuration may be used depending on the needs of the end user or particular application for which the removable elements are intended. As indicated in the present illustration a side by side arrangement of two cards is provided, or the cards may be a self-laminating construction as provided above. The cards or removable elements may be disposed one on top of the other or only a single element may be present. While the card is generally considered to be a “wallet sized” card, one about the standard dimensions of a credit card, the card could also be larger such as to form an informational placard or alternatively could be much smaller such as useful in connection with a key tag or the like.

The material from which the second portion 70 is selected may include paper stock to which a plastic like material or film, such as a MYLAR® polyester or polyethylene or where a polyethylene coating has been applied to one or both surfaces of the paper or portion 70 may be composed of a single layer of plastic or film material. In either event, the thickness of the stock depends on the particular application of the end user and may range from about 0.001 mil to about 25 mils in thickness with about 1 to about 3 mils being preferred. The width of the material may range from about 0.001 inches to about 10 inches and the length is typically 8½ inches up to 17 inches, however, the material can have any approximate width, radius or the like depending on the configuration or geometric arrangement of the product and the pattern selected in connection with the manufacture of the business form card assembly.

Where the first portion 60 and/or second portion 70 are composed of a synthetic or plastic or plastic like material, it has been unexpectedly found that through the use of one or more of the formulas as set forth below that the toner, ink, adhesive or cohesive that is applied, imaged or coated onto the synthetic or plastic like portion adheres better to the “plastic” (used for descriptive purposes) portion of the assembly and is not smeared, easily smudged, wiped off or removed.

Exemplary coatings are as follows:

Formula #1

| Ingredient | Percent by Weight |
|---|---|
| Transwhite 61 | 50% |
| StabilAide | 15% |
| PrintAide | 5% |
| NuCoat 8320 | 30% |
| | 100% |

Formula #2

| Ingredient | Percent by Weight |
|---|---|
| Transwhite 36 | 60% |
| StabilAide/Water | 10% |
| NuCoat 8320 | 30% |
| Catalysts | 3% |
| Vanilla | 3% |
| Total | 100% |

Formula #3

| Ingredient | Percent by Weight |
|---|---|
| Transwhite 36 | 75% |
| NuCoat 8320 | 13% |
| Catalysts | 3% |
| Vanilla | 9% |
| Total | 100% |

Formula #4

| Ingredient | Percent by Weight |
|---|---|
| Sericol | 100% |

The synthetic or plastic like material is coated with one of the exemplary coating formulas provided above through the use of a blade applicator, Meyer rod, analox roll or other suitable coating means understood by those skilled in the art. The thickness of the coating ranges from about 0.001 to about 10 mils with about 0.5 to about 1.5 mils being more preferred and about 0.9 to about 1.2 mils being yet still more preferred.

The coating of the present invention generally includes a first component including a pigment less material ranging from about 0.01% to about 90% by weight and at least a second component ranging from about 0.01% to about 90% by weight of an absorbing agent. A pH stabilizer and drying/wetting agent may also be added to the formula.

Transwhite 36 and 61 are available from Arcar Graphics, LLC of West Chicago, IL and is water based, pigment less ink that includes butyl alcohol, ammonium hydroxide and n-methylpyrrolidone. Transwhite is generally pigment less, but pigments may be added to supplement or compliment the printing that may be applied to the assembly. NuCoat 8320 is available from NuCoat, Inc. of Plymouth, Minn. serves as an absorbing agent. The catalysts suitable for use in the present invention are polyfunctional aziridine available from Arcar Graphics of Ann Arbor, Mich. PrintAide is available from Arcar Graphics of Ann Arbor, Mich. and includes 2-dimethylaminothanol and ammonia and functions as a drying agent or wetting agent in slowing the drying. StabilAide may be mixed with water or any other known component or used alone and is available from Arcar Graphics of Ann Arbor, Mich. and is generally used for pH stabilization. Vanilla or any other fragrance can be used to conceal the smell or odor from the coating and the amount or percentage of which can be manipulated as is necessary in order to accomplish the objective of the use.

Sericol is available from Sericol of North Kansas City, Kans. and includes acrylate ester, vinaly monomer, acrylated urethane, alkanol amine, barium sulfate and a photoinitator. Sericol is a pigment less material having an absorbing agent contained therein as well as being in a prescribed pH range.

The coating for use in the present invention suitable in anchoring toner, ink, adhesive, cohesive and combinations thereof to a substrate. The coating includes a first component ranging from about 0.1% to about 90% by weight and at least a second component ranging from about 0.1% to about 90% by weight. The coating is applied to those areas intended to receive ink, toner, adhesive, cohesive and/or combinations of those items and anchor or hold these elements to the substrate.

The first portion 60 of the business form card assembly is joined to the second portion 70 of the assembly along line 63 which may or may not be concealed by the pattern of material that is applied in connection with creating the lay flat assembly 5 of the present invention. That is, if a transparent coating is applied, such as a clear silicone, the line of demarcation between the first and second portions would be visible. Alternatively, if a clear glassine material is selected the line would also be viewable to the naked eye.

As shown in FIG. 1, three patterns 100, 110 and 120 are used in connection with creating the leveling effect of the present invention. As depicted in FIG. 1, one pattern 100 is applied adjacent or substantially adjacent to a transversely extending end edge 50. The second pattern 110 is applied over the area where the two portions 60 and 70 meet one another and in addition to leveling the particular construction second pattern 110 also serves to hold the two portions 60 and 70 together to form a substantially homogenous, or single planar assembly 5.

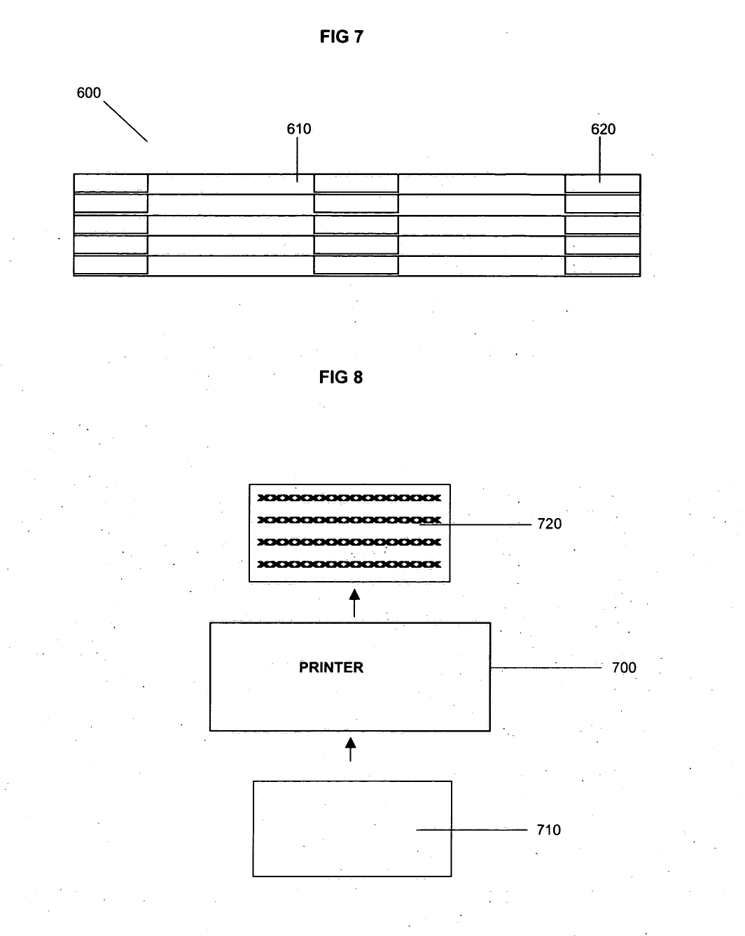

A third pattern 120 is provided adjacent or substantially adjacent to the other transversely extending end edge 40 to complete the depiction in FIG. 1 and to prevent the tail end of the assembly 5 from being at a level different from or lower than that of the rest of the assembly when placed in a stack configuration as shown in FIG. 7. While FIG. 1 depicts the first and third patterns 100 and 120 being adjacent the transversely extending edges, it should be understood that the patterns 100 and 120 may also be spaced from the edges 40 and 50 so as to run parallel or substantially parallel to the edges, or may run up to a majority of the portion to which they have been applied or encompass more than a majority of the portions 60, 70 on which they are applied.

The patterns 100, 110 and 120 may be of the same thickness or varying in thickness if a strip of material is applied or alternatively differ in coating weights and thicknesses if a coating or ink is used. That is, if the first portion of the assembly has a thickness of about 3 mils and the second portion of the assembly is about 5 mils, a strip of material or coating applied to the first portion should be for example about 3 mils and the strip or coating applied to the second portion is about 1 mil so that the total thickness through the area of the form and material is equal for both portions at about 6 mils.

In addition, it should be understood that one pattern may be of one type of material and the second and other patterns may be of a second and distinct type of material. For example, glassine may be used for the first pattern and a wax or starch based coating used for the second pattern.

The patterns as used in FIG. 1 and in an exemplary embodiment are created through the use of continuous strips of material such as highly calendared paper, machine glazed paper, glassine or tape or plastic material such as polyester or polyethylene based material (e.g. PET). It should be understood that instead of the pattern running adjacent the transversely extending edges that the patterns may also be applied along or adjacent or spaced from the longitudinally extending sides. In addition, the patterns of leveling aids may also be disposed so as to run diagonally between the transversely extending edges or longitudinally extending sides. Patterns can also be applied in combinations of parallel, diagonal, perpendicular and random arrangements so that the leveling effect is still achieved. Placement of the patterns is at the discretion of the manufacturer and in light of conditions or requirements of the end user.

The cards 90 as shown in FIG. 1 are depicted in a side by side arrangement and are typically created through the use of a die to form a series of cuts and ties, perforations, crush arrangements, laser perforating or cutting and are separated from the second portion 70 by lines generally depicted by reference numeral 130. In addition to the use of dies to create the separation point between the removable element and the portion from which it is to be removed, the separation can also be created by laser perforating and cutting and the like. The cards 90 may be printed with similar indicia, complementary indicia, such as membership cards for a husband and wife, or may have completely unrelated indicia, such as different tickets for events.

The coating 150 (shown only as a partial coating in FIG. 1) as described above would be applied in either a spot, pattern or full coating to the portion from which the cards 90 are die cut from. As stated previously, the coating serves to anchor toner, ink, adhesive, cohesive and combinations thereof to the substrate. Anchoring of adhesive and cohesive would come in use during the application of adhesive or cohesive to the perimeter of the surface or portion of the assembly. The coating would be applied prior to the application of any adhesive or cohesive as well as prior to the imaging, printing or other rendering of images or information on the substrate. The coating 150 is applied via the use of a blade applicator, screen, Meyer rod, anilox roller or other means suitable for use in applying the coating.

Referring briefly to FIG. 2, the obverse face of the form assembly 5 as depicted in FIG. 1 is shown having a second face 105 and first and second portions 60 and 70. Here coating 150 is applied in a spot configuration and only in those areas receiving adhesive, cohesive toner, ink, any of them or all of them or combinations of them. For illustrative purposes, the coating is only applied in the area of the printing in FIG. 2.

It should be understood that significant portions of the description included above is applicable to the successive figures and is not necessarily repeated for the sake of brevity. One with skill in the art would recognize the transferability and juxtaposition of such elements in connection with the remaining portion of the specification.

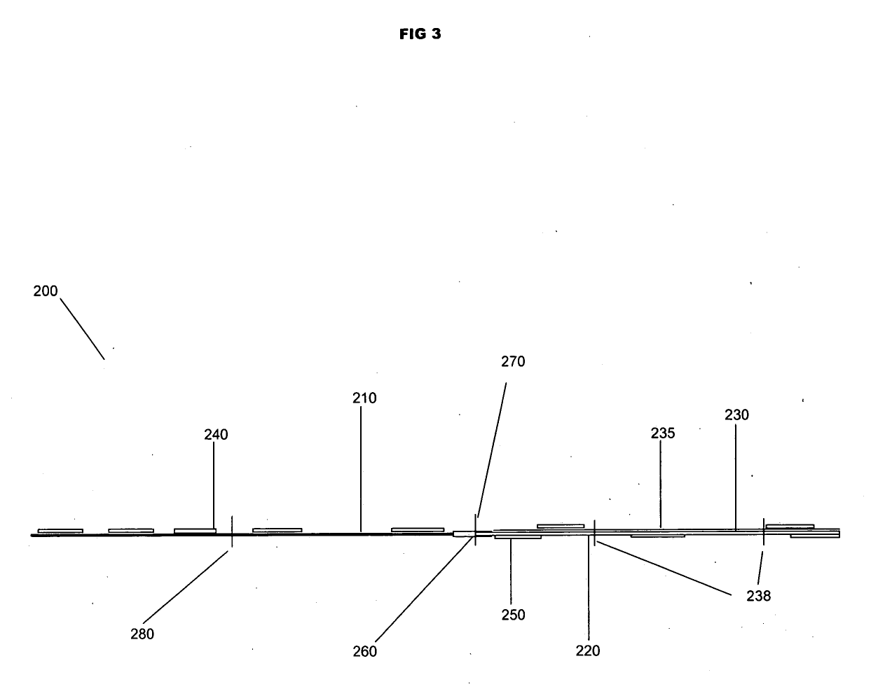

Turning now to FIG. 3, the business form card assembly is depicted by reference to numeral 200. The assembly 200 has first and second portions 210 and 220, respectively which are laid next to one another at line 270. The assembly is shown with a card arrangement 230 which is defined by die cuts, perforation, crush zones or the like at 238.

Die cutting and perforating are typically done with blades, lasers or dies that form a series of cuts and ties that will correspond to the area being die cut in the card. In order to create a crush zone, a wax based or starch based coating is applied over the area of the cards and then a crushing die is brought down into engagement with the area of the coating corresponding to the cards. Then by bending the card carrying material the combination of the coating along with the crush die enable the cards edges to fracture and to separate from the card carrying material.

FIG. 3 further illustrates the fold lines 260, 280 that enable the assembly to be “Z” or “C” folded as described earlier. Coating 235 illustrated as being applied in the area of the cards 230 to anchor the toner, ink, but it should be understood that the coating may be applied elsewhere to anchor adhesive, cohesive and/or combinations or any of them to the second portion 220. Adhesive and/or cohesive patterns 240 and 250 are provided to aid in the sealing or securing of the form construction.

FIG. 4 of the present invention shows a business form card assembly 300 having first and second portions 360 and 370 respectively. The form assembly has first and second longitudinally extending side edges 320 and 330, and first and second transversely extending end edges 340 and 350. A pair of fold lines 362 enables the folding of the construction. One or more cards or removable elements 380 may be removed from the second portion 370 and are separable though the use of die cuts and the like. Cohesive and or adhesive pattern 364 is provided to enable sealing of the assembly in a “Z” folded arrangement. Printing and the coating referred to simply by reference to numeral 390 are also provided and described previously.

Now turning to FIG. 5 a still further depiction of the present invention is provided and the business form card assembly is generally referred to by reference to numeral 400. The form assembly 400 is provided with first and second longitudinally extending side edges 410 and 420 and first and second transversely extending end edges 430 and 440. The assembly is provided with an adhesive/cohesive pattern 422 to enable the sealing of the form in a “Z” folded arrangement.

Cards 470 are illustrated in a side by side configuration and are separable from the substrate through perforation lines, die cuts, crush patterns and the like illustrated by reference to numeral 470. Cards 470 may be printed 490 with any information relating to the particular transaction that is under contemplation and the indicia may be identical, or dissimilar depending on the needs of the particular end user or customer for whom the business form card assembly 400 is being produced. The coating is applied in at least the areas of the adhesive 422 (where the adhesive resides on synthetic or plastic material) and printing 490 in the second portion but may be applied throughout the entire area of the second portion. The coating as described herein provides toner or ink jet anchorage to the surface of the cards to prevent the indicia imaged, printed or otherwise rendered from being removed from the card surface.

Coatings useable in connection with this invention include for example silicone, wax pigment less, ammonia and starch based coatings and other release materials that create a differential or roughened surface and which can be applied in varying thicknesses so as to accommodate for the differential in thickness created by the removable element portion, card products or joining segment. The coatings use in the present invention may also be stippled, dimpled, have ridges, dots or other designs or shapes imparted to them and in the reduction of surface affinity or increase the height of the particular coating.

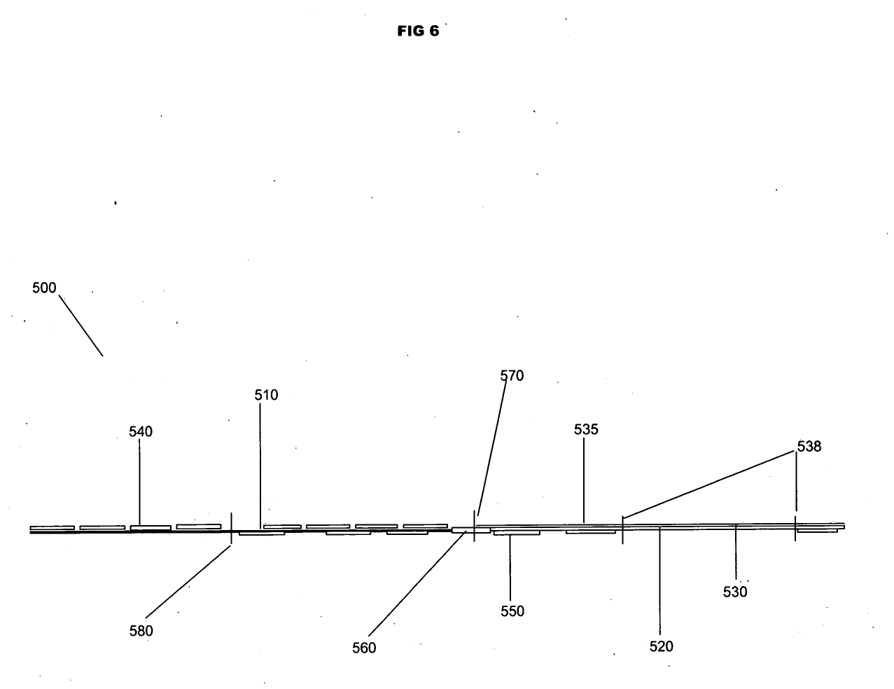

FIG. 6 represents a further side view of the present invention of the assembly shown in FIGS. 4 and 5 and depicts business form assembly generally by reference to numeral 500. Pattern 560 is used to hold the two portions 510 and 520 together which meet at line 530. Removable elements 520 are also shown in position on the substrate and delineated by die cuts 538. A coating 535 has been applied to the second portion 520 to anchor printing, adhesive and or cohesive as well as in the area of the cards 530.

FIG. 7 shows a series of assemblies of the present invention generally designated by numeral 600 which is provided with a series of leveling aids 620 in order to create a lay flat stack created for such individual assemblies 610 that maintains it's relatively square, cube or rectangular shape.

It has also been unexpectedly found that through the use of the materials described above, glassine, machine glazed papers, starch, wax, ammonia an pigment less and silicone based coatings, that the business form card assemblies when placed in a stack do not stick to one another and hence do not encounter the problem attributed to static build up of the form assembly. That is the materials reduce the surface affinity between forms, enabling the forms to release from one another in the stack. With respect to the coatings and inks that may be applied the surface of the coatings may have a roughened or discontinuous surface so as to facilitate the separation of sheets from one another. In addition, it is believed that the materials and coatings as contemplated by the present invention also facilitate the feeding of the sheet into the printer or other processing apparatus as well as the traversing of the equipment.

The present invention is a highly efficient business form card combination that is both economical to manufacture and overcomes many of the aforementioned difficulties encountered by other prior art form/card constructions. The present business form card construction does not suffer from such problems as static, pad lean or slope, feeding difficulties and the like.

One of the most important things with respect to new product innovations is the need to effectively market and communicate the new product to potential customers and end users of the product. Such marketing typically includes the creation of marketing collateral associated with the features of the business form card assembly and then selling the assembly in connection with that marketing collateral and then distributing the business form card assembly to potential end users and customers. Customers can include distributors of such products as well as office supply stores, retail and warehouse outlets that may not be end users, but may repackage and resell the products to end users or third parties.

Marketing collateral as used herein includes the use of scripted or prepared material that are distributed through audio and visual communication mediums, over a global communication network, through printed mediums such as newspapers, trade publications, magazines, fliers, handouts and the like.

The lay flat configuration of the present invention also enables the form assembly 710 to be fed through the processing or printing equipment 700 in a landscape or long side first format thus reducing print head wear and expediting processing of the form assemblies with removable elements. As illustrated in FIG. 8, a printer 700 is provided and the form assembly of the present invention 710 is fed to the printer in the landscape or long side first arrangement and emerges with printing 720 in that configuration.

It will thus be seen according to the present invention a highly advantageous business form assembly with integral cards has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A business form, comprising;
a first substrate having a first property and having first and second longitudinal side edges and first and second transverse end edges;
a second substrate having a second property, distinct from said first property, said second substrate being joined to said first substrate along one of said side or end edges;
at least one removable element provided with one of said first and second substrates;
a coating applied to at least one of said first and second substrates, said coating anchoring toner, ink, adhesive, cohesive and combinations thereof to said at least one of said first and second substrates;
a plurality of patterns disposed between one of said sides or end edges of at least one of said first and second substrates, said plurality of patterns being applied to said at least one of said first and second substrates and said plurality of patterns spaced from one another;
at least one of said plurality of patterns connecting said first substrate to said second substrate; and
wherein said plurality of patterns with said first and second substrates create a substantially planar business form assembly having at least one removable element.

2. A business form as recited in claim 1, wherein said patterns are composed of continuous, discontinuous, segmented, uninterrupted arrangement and combinations thereof.

3. A business form as recited in claim 2, wherein said patterns are stripes, strips, dots, geometric shapes, printed designs and combinations thereof.

4. A business form as recited in claim 1, wherein said coating has at least a first component including between 0.01% and 90% by weight of an absorbing agent.

5. A business form as recited in claim 1, wherein said substrates are selected from a group including cellulosic, plastics, metal based films and combinations thereof.

6. A business form as recited in claim 1, wherein the spacing between said plurality of patterns extends less than an area between one of said side edges or said end edges.

7. A business form as recited in claim 1, wherein a plurality of said planar business form assemblies when placed in a stack will have a substantially square, cube or rectangular configuration.

8. A business form as recited in claim 1, wherein said plurality of patterns are selected from a group including glassine, machine glazed paper, highly calendared paper, starch or wax based coatings, silicone coatings, pigment less coatings, ammonia based coatings, alcohol based coatings, polyethylene, polyester based materials and combinations thereof.

9. A business form as recited in claim 8, wherein the coatings have a roughened surface.

10. A business form as recited in claim 1, wherein each of said first and second substrates has at least one pattern disposed thereon.

11. A business form as recited in claim 1, wherein said plurality of patterns may be provided with indicia.

12. A business form as recited in claim 1, wherein said plurality of patterns decrease surface affinity between said planar business form card assemblies.

13. A business form as recited in claim 4, wherein said coating includes at least a second component including a pigment less material.

14. A business form as recited in claim 1, wherein said element removable from the form assembly is selected from a group including cards, tags, coins, chips, labels and combinations thereof.

15. A business form as recited in claim 1, wherein said removable element is a self laminating card.

16. A method of communicating the benefits of a business form assembly having a removable element, comprising the steps of;
producing a number of business form assemblies having at least one removable element, said assemblies having at least first and second portions with a coating applied to at least a portion of said one of said first and second portions, said coating anchoring toner, ink, adhesive, cohesive and combinations thereof to said at least one of said first and second portions, with said first and second portions having at least an area of different thickness from one another; one of said first and second portions having at least one removable element that creates at least a portion of said different thickness and each of said first and second portions having a pattern of material disposed thereon to create a substantially planar business form assembly with said removable element'so that when said assemblies are placed in a stack with other business form assemblies with said at least one removable element said stack will have a square, cube or rectangular configuration;
creating marketing collateral with respect to using said business form assemblies;
selling said business form assemblies in connection with said marketing collateral to customers or end users; and
distributing said business form assemblies with said removable element.

17. A method as recited in claim 16, wherein said customers are selected from a group including distributors, office supply stores, retail outlets, warehouse stores and combinations thereof.

18. A method as recited in claim 16, wherein said removable element is selected from a group including cards, tags, coins, chips, labels and combinations thereof.

19. A method as recited in claim 16, wherein said marketing collateral includes information disseminated through audio, audio visual, print, global communications network and combinations thereof.

20. A business form assembly, comprising;
a substrate having first and second portions distinct from one another, said first and second portions are joined one to another through a first pattern of material applied along an edge of each of said first and second portions;
one of said first and second portions having at least a second pattern of material disposed thereon spaced from said first pattern;
a coating applied to a portion of at least one of said first and second portions, said coating anchoring toner, ink, adhesive, cohesive and combinations thereof to said at least one of said first and second portions;
at least one removable element contained within one of said first and second portions, said removable element having a thickness different than at least one of said first and second portions;
said first and second patterns with said removable element and said first and second portions cooperating to form a substantially coplanar assembly; and
said first and second portions with said removable element and said first and second patterns of material are connected to additional business form assemblies to create a continuous business form arrangement.

21. A business form assembly as recited in claim 20, wherein said first and second patterns of material are selected from a group including glassine, machine glazed paper, highly calendared paper, wax or starch based coatings, silicone coatings, ink and combinations thereof.

22. A business form assembly as recited in claim 20, wherein said at least one of said first and second patterns of material are provided with indicia.

23. A business form assembly as recited in claim 20, wherein said removable element is selected from a group including cards, tags, coins, chips, labels and combinations thereof.

24. A stack of business form assemblies having at least one removable element, comprising;
a removable element, said removable element having a different thickness that an individual business form assembly;
a plurality of business form assemblies, each of said assemblies having a first and second portion joined to one another by a first pattern of material and one of said first and second portions having at least a second pattern of material;
a coating applied to a portion of at least one of said first and second portions to anchor toner, ink, adhesive, cohesive and combinations thereof to said at least one of said first and second portions;
said first and second patterns of material along with said at least one removable element cooperate to create a substantially planar assembly; and
wherein said plurality of business form assemblies forms a square, cube or rectangular shaped stack ranging from about 2 up to about 10,000 assemblies.

25. A stack of business form assemblies as recited in claim 24, wherein said material is selected from a group including glassine, machine glazed paper, highly calendared paper, wax or starch based coatings, silicone, polyethylene, polyester based materials and combinations thereof.

26. A stack of business form assemblies as recited in claim 24, wherein said material may be provided in a format selected from a group including continuous, discontinuous, segmented, regular, irregular and combinations thereof.

27. A stack of business form assemblies as recited in claim 24, wherein said material has reduced surface affinity between successive form assemblies.

28. A stack of business form assemblies as recited in claim 24, wherein said removable element is selected from a group including cards, tags, coins, chips, labels and combinations thereof.

29. A method of using a business form assembly, comprising the steps of;
providing a series of business form assemblies, each of said assemblies having discrete first and second portions with said first and second portions joined to one another along an end edge, each of said assemblies having a landscape and a portrait format, at least one of said first and second portions provided with a removable element having a thickness different than that of at least one of said first and second portions and at least a portion of one of said first and second portions is provided with a coating to anchor toner, ink, cohesive, adhesive or combinations thereof to said at least one of said first and second portions; and each of said first and second portions provided with at least one pattern of material to offset the thickness of said removable element and said patterns of material reducing surface affinity between successive business form assemblies;
stacking said business form assemblies for processing through a printer or other handling equipment; and
feeding said business form assemblies in a landscape format through said printer or other handling equipment.

30. A method as recited in claim 29, wherein said removable element is selected from a group including cards, tags, coins, chips, labels and combinations thereof.

31. A method as recited in claim 29, wherein said first and second pattern of material is selected from a group including glassine, machine glazed paper, highly calendared paper, wax or starch based coatings, silicone and combinations thereof.

32. A method as recited in claim 29, wherein said patterns may be provided in a format selected from a group including continuous, discontinuous, segmented, regular, irregular and combinations thereof.

33. A coating for anchoring toner, ink, adhesive, cohesive and combinations thereof to a substrate comprising;
a first component including a pigment less material ranging from about 0.01% to about 90% by weight and at least a second component ranging from about 0.01% to about 90% by weight of an absorbing agent.

34. A coating as recited in claim 33, including a third component for stabilizing pH.

35. A coating as recited in claim 34, including a drying agent.
